(19) United States
(12) Patent Application Publication
(10) Pub. No.: US 2025/0238466 A1
(43) Pub. Date: Jul. 24, 2025

(54) GENERATING KNOWLEDGE BASE QUERIES AND OBTAINING ANSWERS TO KNOWLEDGE BASE QUERIES

(71) Applicant: Telefonaktiebolaget LM Ericsson (publ), Stockholm (SE)

(72) Inventors: Fitsum Gaim GEBRE, Järfälla (SE); Jiangning GAO, Solna (SE); Rerngvit YANGGRATOKE, Järfälla (SE); Vincent HUANG, Sollentuna (SE)

(21) Appl. No.: 18/705,126

(22) PCT Filed: Oct. 28, 2021
(86) PCT No.: PCT/EP2021/080050

§ 371 Date: Apr. 26, 2024

(51) Int. Cl. G06F 16/903; G06F 40/40; G06V 10/40; G06V 10/77; G06V 10/82

(52) U.S. Cl. CPC G06F 16/90335; G06V 10/40; G06V 10/7715; G06F 40/40; G06V 10/82

(57) ABSTRACT

A method of retrieving an answer to a query relating to an object from a knowledge base includes receiving an image of the object, identifying a location associated with the object, and retrieving an object feature model associated with the location. The object feature model including object features associated with objects present at the location. The method further includes extracting object features from the image using the object feature model. The object features include features associated with the objects. The method further includes receiving a language-based query associated with the object, analyzing the query to identify an aspect of the query, and combining information from the query and the extracted object features based on the identified aspect of the query to form a unified query for submission to the knowledge base. The unified query is submitted to the knowledge base to obtain an answer to the unified query.

### TECHNICAL FIELD

The present disclosure relates to systems and methods for interacting with a knowledge base using queries. In particular, the present disclosure relates to systems and methods for generating queries for use with a knowledge base and for obtaining information from a knowledge base.

### BACKGROUND

Recent advances in natural language processing (NLP) make it possible to build language models that can be used for obtaining information, such as product information, from a knowledge base through a natural language based question/answer process. When a question is formulated, NLP is used to determine the key components of the question, which are then used to generate a query that can be input to a knowledge base.

FIG. 1 illustrates a system in which a user 10, such as a field engineer, has access to an image of an item of equipment 12 shown in an image 15, and wishes to obtain information about the equipment 12, such as repair procedures, maintenance procedures, etc. The user 10 may formulate a query via a QA system 14 regarding the issue at hand. The query is then submitted to a product knowledge base 16, which is a database and associated logic that can provide information about one or more items in response to queries that are input to the knowledge base 16. The knowledge base 16 generates a response by predicting one or more database entries that are relevant to the query and returning the results to the user 10.

To generate the query, the Q/A system 14 may, using natural language processing, process a natural language question that is input by the user 10. That is, to generate the query, the field engineer may have to manually interpret the image 15, such as by determining what model of a telecom equipment is depicted in the image 15, to formulate the right question to ask. If the equipment 12 is installed on a site which is difficult to reach by the user 10, a drone can be used to inspect and photograph the site. However, the resulting image 15 may be difficult to interpret by the user 10.

There are at least three published technologies that address the problem of generating queries from images. A first solution, described in [1] and [2], proposes a unified representation for image and text. This approach requires a large amount training data to train the representations and it does have question/answer implementation.

A second solution described in [3]proposes an approached called ArticleNet, to select relevant articles from Wikipedia for a question/image pair based on keywords, and uses a neural network to obtain answers from the retrieved articles.

A third solution described in [4] is to utilize image-captioning models to convert image to text and apply reading-comprehension models to answer the questions (avoid learning joint embedding between text/image). In other words, the solution converts the text-and-image Q/A problem into multiple text Q/A problems (original text and text from image-captioning model).

### SUMMARY

A method of retrieving an answer to a query relating to a physical object from a knowledge base includes receiving an image of the physical object, identifying a physical location associated with the physical object, and retrieving an object feature model associated with the physical location. The object feature model including object features associated with objects present at the physical location. The method further includes extracting object features from the image using the object feature model. The object features include features associated with the objects present at the physical location.

The method further includes receiving a language-based query associated with the physical location, analyzing the language-based query to identify an aspect of the language-based query, and combining information from the language-based query and the extracted object features based on the identified aspect of the query to form a unified query for submission to the knowledge base. The unified query is submitted to the knowledge base to obtain an answer to the unified query.

The method may further include analyzing the image to identify the physical location.

Retrieving the object feature model is performed in response to identifying the physical location.

The method may further include analyzing the language-based query to identify missing information that is missing from the language-based query, wherein combining information from the language-based query and the extracted object features includes obtaining the missing information from the extracted object features and combining the missing information obtained from the extracted object features with the information from the language-based query.

The object feature model may include a site-specific computer vision model associated with the physical location. The object feature model may include a list of products present at the physical location.

The method may further include generating a plurality of unified queries based on information from the language-based query and the extracted object features, determining validity of the plurality of unified queries, and filtering the plurality of unified queries to eliminate invalid queries.

In some embodiments, extracting the object features may include analyzing the image with a neural network.

The aspect of the language-based query may include an intent of the language-based query, and the method includes analyzing the language-based query with a sequence classification model to determine the intent of the language-based query. The missing information may be identified based on the determined intent of the language-based query.

In some embodiments, the aspect of the language-based query may include an entity associated with the language-based query, and wherein the method includes analyzing the language-based query with a token classification model to determine the entity associated with the language-based query.

A system for retrieving an answer to a query relating to a physical object from a knowledge base includes an image recognition subsystem configured to receive an image of the physical object, to identify a physical location associated with the physical object, to retrieve an object feature model associated with the physical location, the object feature model including object features associated with objects present at the physical location, and to extract object features from the image using the object feature model, the object features including features associated with the objects present at the physical location. The system 100 further includes a question analysis subsystem configured to receive a language-based query associated with the physical location and to analyze the language-based query to identify an aspect of the language-based query, and a question answering subsystem configured to combine information from the language-based query and the extracted object features based on the identified aspect of the query to form a unified query for submission to the knowledge base and to submit the unified query to the knowledge base to obtain an answer to the unified query.

A knowledge base interface system according to some embodiments includes a processor, a communication interface coupled to the processor and configured to communicate with a knowledge base, and a memory coupled to the processor. The memory includes computer readable instructions that when executed by the processor cause the system to perform operations including receiving an image of a physical object, identifying a physical location associated with the physical object, retrieving an object feature model associated with the physical location, the object feature model including object features associated with objects present at the physical location, extracting object features from the image using the object feature model, the object features including features associated with the objects present at the physical location, receiving a language-based query associated with the physical location, analyzing the language-based query to identify an aspect of the language-based query, combining information from the language-based query and the extracted object features based on the identified aspect of the query to form a unified query for submission to the knowledge base, and submitting the unified query to the knowledge base to obtain an answer to the unified query.

Some embodiments provide a computer program comprising program code to be executed by processing circuitry of an apparatus, whereby execution of the program code causes the apparatus to perform operations according to any of the foregoing embodiments.

Some embodiments provide a computer program product comprising a non-transitory storage medium including program code to be executed by processing circuitry of an apparatus, whereby execution of the program code causes the apparatus to perform operations according to any of the foregoing embodiments.

### BRIEF DESCRIPTION OF THE DRAWINGS

FIG. 1 illustrates a conventional system/method for querying a knowledge base.

FIG. 2 illustrates a system/method for querying a knowledge base according to some embodiments.

FIG. 3 illustrates functional aspects of a knowledge base interface system according to some embodiments.

FIG. 4 illustrates operations a knowledge base interface system according to some embodiments.

FIG. 5 illustrates an example system and operation for performing object recognition in a knowledge base interface system according to some embodiments.

FIG. 6 illustrates an example system and operation for performing textual analysis of a natural language question in a knowledge base interface system according to some embodiments.

FIGS. 7 and 8 illustrate an example operations of knowledge base that may be used by a knowledge base interface system according to some embodiments.

FIG. 9 illustrates example operations a knowledge base interface system according to some embodiments.

FIG. 10A is a block diagram that illustrates elements of a knowledge base interface system according to some embodiments.

FIG. 10B illustrates various functional modules that may be stored in the memory of a knowledge base interface system according to some embodiments.

FIG. 11 is a flowchart that illustrates operations of a knowledge base interface system according to some embodiments.

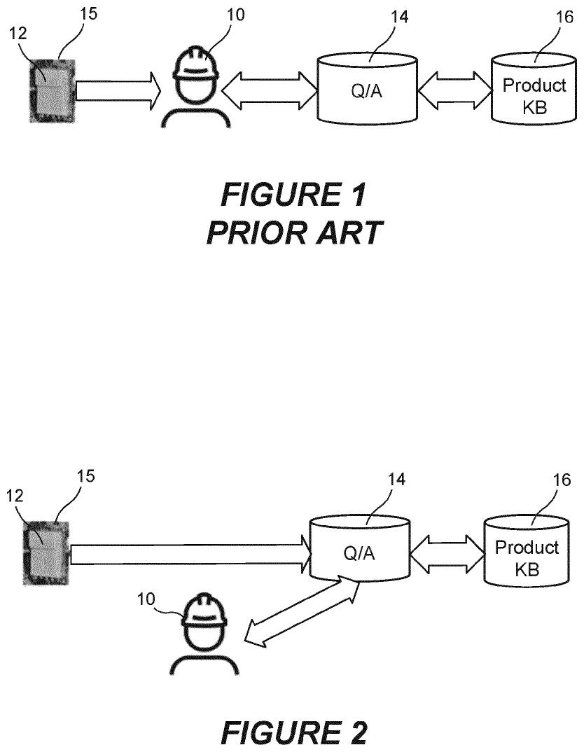

### DETAILED DESCRIPTION OF EMBODIMENTS

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Current approaches for querying a knowledge base only use information extracted from text. That is, information described with images has not been used in the knowledge base context. This limits the utility of a knowledge base in situations in which an image associated with the question is available. For example, a field engineer working on a site, such as a telecommunications (telecom) installation, may have access to drone or camera images and/or video of the installation that may be helpful in understanding a particular issue. In that case, it is desired for the field engineer to be able to directly query the knowledge base for product information using the image or video.

Accordingly, there is a need for systems/methods that can generate knowledge base queries for obtaining information about physical objects, such as telecommunications products, where the knowledge base queries are based on both text and image input. It is desired to extract useful information from the image automatically and combine with product information to obtain an answer that may be more relevant than could be obtained by text input alone.

Currently, there is not a good solution that combines the knowledge from a language model and information from an image. There are solutions for object identification from images, but they are not linked to a language model, and cannot be used to enhance question/answering system. There is no solution for querying real time product information based on a combination of real time image and product information from documents.

Some embodiments described herein provide systems/methods that automate the manual process of combining information from images and text to formulate a knowledge base query using artificial intelligence and machine learning. In particular, using systems/methods described herein, a user, such as a field engineer, can pose a question that incorporates both text and image, where the Q/A system will automatically infer and determine the appropriate answer by incorporating information from both the text and the image.

In particular, some embodiments provide a method of combining information from a natural language input (text) and visual input (images) in a product-information question-answering system. The method includes the steps of:
(a) Identifying a telecom site based on information in an images and a telecom site database;
(b) Executing a site-specific computer-vision model to extract product features;
(c) Identifying missing/required information based on the natural-language question;
(d) Composing a unified query by combing required information and the product features; and
(e) Determining the answer based on the unified query.

Embodiments described herein may have certain advantages. For example, some embodiments may allow for combining information from text and images in an automatic way based on information extracted from the text. Some embodiments may enable question answering for a telecom site without manually interpreting the images, which may reduce manual effort required to generate queries. This may increase the efficiency of remote maintenance, which may reduce operational expenses for a telecom network operator. Moreover, some embodiments described herein may not require explicit annotations of text and image pairs.

Some embodiments described herein are generally illustrated by FIG. 2, which illustrates a user 10 who submits a natural language question to a Q/A system 14. The Q/A system also receives an image 15 depicting, for example, an item of equipment 12 related to the natural language question. The Q/A system 14 analyzes the image and the question and, based on the analysis, formulates a query that is based on both information extracted from the natural language question and information extracted from the image 15. The combined query is submitted to a product knowledge base 16, which generates an answer from product documentation based on the combined query.

Information about a specific product can be obtained from product documentation. An image can be used to identify the product. For example, in a telecom installation, product documentation may provide information about a product depicted in image 15, which is an antenna integrated radio unit model AIR 5121. Based for example on location metadata in the image, it may be possible to a specific AIR 5121 from a network installed at a specific physical location. A user, such as a field engineer, may want to ask questions about the product, such as “what is wrong with this product?” The answers could be “a bad cable connection,” or “software upgrade needed.” The answers may come from different sources which can be stored in a knowledge base.

Other potential questions that could be handled are “How do I replace this product?”, “What tools do I need to replace this product?”, “What are the dimensions of this product”, “Does this product support 4G/5G”, “What is the volume this product?” etc.

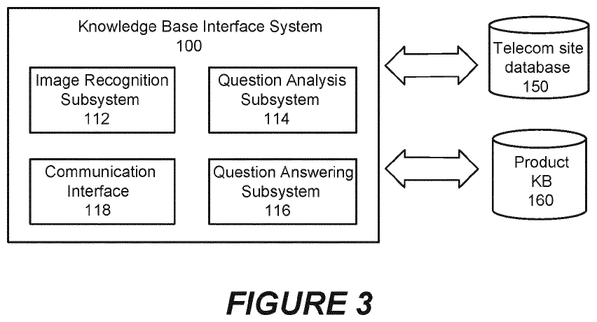

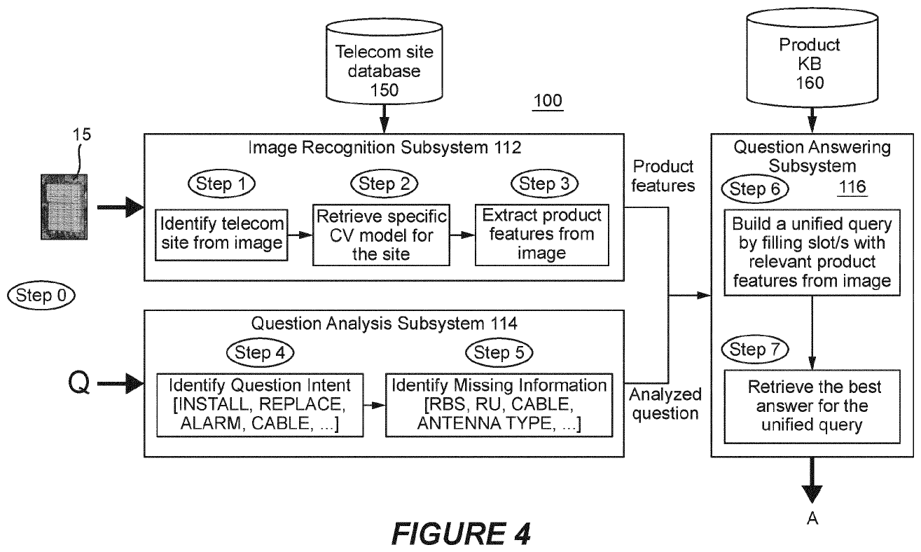

Referring to FIG. 3, some embodiments described herein provide a knowledge base interface system 100 that has four major components/functions, namely, an Image Recognition Subsystem 112, a Question Analysis Subsystem 114, a Question-Answering Subsystem 116 and a Communication interface 118. The system 100 interacts with a telecom site database 150 that stores information about one or more telecom sites, such as information about equipment installed at the sites, and a product knowledge base 160 that contains articles and information about equipment, such as the equipment installed at the telecom site. The purpose and function of each of these components will now be described with reference to FIG. 4.

Referring to FIG. 4, initially (step 0) a natural language question Q is input by a user to the Question Analysis Subsystem 114 and an image 15, such as a drone survey image, is input to the Image Recognition Subsystem 112.

The objective of the Image Recognition Subsystem 112 is extract visual properties and representations from images that are relevant the questions that may be submitted to the product knowledge base 160. Referring to FIG. 4, the Image Recognition Subsystem 112 performs three main operations: telecom site identification (step 1), retrieval of trained computer vision (CV) models (step 2), and extraction of product features based on visual representations in the image (step 3).

The purpose of site identification is to uniquely identify a specific site from information in the image 15. In particular, site identification may be performed by extracting on geo-tagged meta data, such as a site coordinate (latitude and longitude) from the image 15 (which may, for example, be stored in EXIF format).

Site identification may further include using the site coordinates to locate a specific telecom site from the telecom site database 150. This can be done by retrieving data from the telecom site database 150 and finding a telecom site with matching site coordinates, e.g., within a threshold distance of the image coordinates.

The purpose of retrieving specific trained CV models for the identified site is to narrow down the telecom equipment space based on the identified site. In practice, there may be a very large number of different telecom equipment models in the field (e.g., at least in the order of 3000+ telecom equipment models). As a result, it may be technically infeasible to have a robust model that is searchable purely by image. However, by identifying a specific telecom site, the system can utilize the prior knowledge of what equipment is installed on the site to enhance the performance of an image classification system that identifies the equipment from the image. For example, knowing the specific telecom location may reduce the search space from ˜3000 telecom equipment models to about 30 to 40 telecom equipment models.

Site identification may include retrieving a list of installed telecom equipment from a telecom site database for the identified site. For each identified item of equipment, the image recognition subsystem may use trained CV models to detect visual properties from the image 15.

For step 3 in FIG. 4 (the extraction of product features from the image 15), the retrieved CV models may be used by an object detection algorithm to extract product features from the image 15 in the form of a list of textual items identified in the image 15. For example, an image 15 taken of a telecom installation may be analyzed by an object detection algorithm using the retrieved CV models and determined to include items such as an “RRU”, a “Radio 2203”, a “Cable XYZ,” etc. “Product features” refers to product information that can be observed visually from the images including product identification, product installation configuration, product operational state, etc. For example, each product feature can be modelled by assigning it to a class and can be detected using an object detection algorithm. Object detection algorithms are well known in the art. Examples of object detection algorithms that can be used include Fast R-CNN, Faster RCNN, Yolov3 [6].

Product identification refers to identification of the equipment type (e.g., antenna, remote radio unit, tower mounted amplifier, microwave, . . . , etc), equipment vendor (e.g., Ericsson, Huawei, Nokia, . . . , etc), equipment model (e.g., Radio 2203, Radio 2012, Air 3000, . . . ), etc.

Product installation configuration refers to the configuration of a particular type of equipment. For example, radio configuration may include number of sockets, mounting configuration, cable connection (connected/disconnected), etc.

The product operational state may include the state of an operational light (turned on/off), a condition light (turned on/off), an alarm (turned on/off), an enclosure condition (open/close), socket looseness (loose/tight), rust (rusty/not rusty), etc.

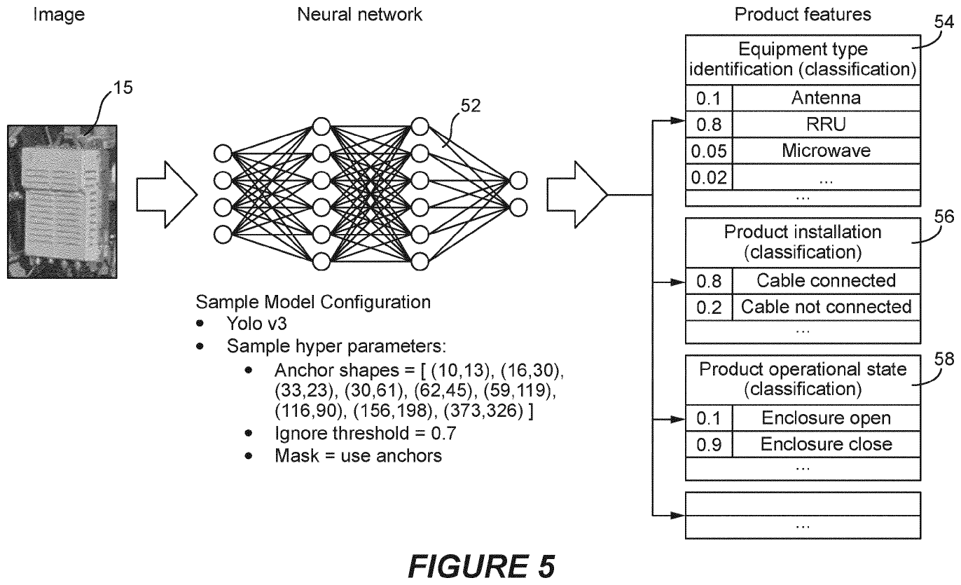

FIG. 5 presents an illustrative example of how this step can be performed in practice, elaborating on sample input data, sample CV model (YoloV3) including its hyper parameters, and sample output data. In particular, an image 15 may be input into a neural network (NN) 52 that is trained for object recognition using the CV model with the indicated sample hyperparameters. The output of the NN may include a classifications of equipment type 54, product installation details 56 and product operational state 58.

In case of multiple images, the extracted list of textual items can be simply merged to represent joint information from all images.

Referring again to FIG. 4, the Question Analysis Subsystem 114 will now be described.

The objective of the Question Analysis Subsystem 114 is to determine the information need of the user from the question and to identify the type of information required to be extracted from the image. This subsystem performs two main operations, illustrated in FIG. 4 as step 4 (Identify Question Intent) and step 5 (Identify Missing Information).

For identifying question intent in step 4, the system 100 may use a sequence classification model that receives as an input a natural language question formulated by a user (such as a field engineer), and returns, as an output, a most probable intent-class of the natural language question from a set of predefined classes. For this, the most common intents of field engineers are pre-defined, such as product installation, replacement, hoisting cables, alarm handling, troubleshooting, etc. This can be implemented using known Natural Language Understanding (NLU) approaches. To achieve deep semantic matching of questions to intents, a large language model, e.g., BERT [7], RoBERTa [8], may be used to obtain a dense representation of the input. The representation is then classified into the predefined intents [labels] with additional linear layers.

In step 5, the question is analyzed to identify information that is missing from the question. Each defined intent has corresponding defined information need. For example, a question about installation of radio requires the exact radio model/family [RADIO_PRODUCT entity]. Other intents might require knowing the cable type [CABLE_TYPE entity], antenna type [ANTENNA entity], etc. Based on the intent identified in the previous step this subsystem may use a predefined map to identify the required information that needs to be extracted from the image.

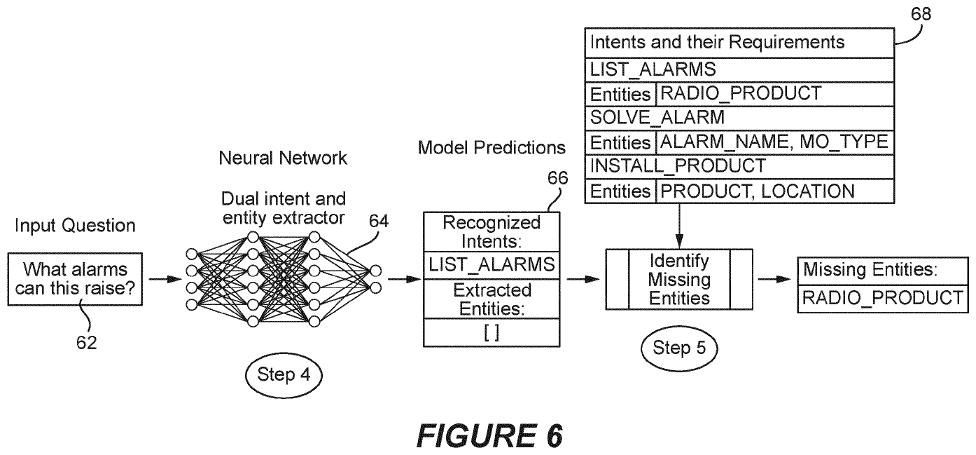

FIG. 6 illustrates an example implementation of the operations of question intent recognition and missing entity identification by a Question Analysis Subsystem 114. As shown in FIG. 6, in step 4, a natural language question 62 is input to a neural network 64 that is trained to extract intents and entities from the question. The model predicts a list 66 of recognized intents and extracted entities from the question. In this example, the model may recognize the intent of “LIST_ALARMS” from the question “what alarms can this raise?.” In this example, the model does not recognize an entity (e.g., a product or item of equipment, or a property of an item of equipment) from the natural language question.

In step 5, the Question Analysis Subsystem 114 compares the recognized intent to a table 68 of intents and associated entities to identify missing information that is needed to construct a useful query and that needs to be extracted from the image 15. The table 68 contains records of intents, such as LIST_ALARMS, SOLVE_ALARM, INSTALL_PRODUCT, etc. Each intent has a list of entities that are associated with the intent. That is, each intent is associated with one or more entities that relate to the intent and that are necessary or helpful to locating information that addresses the intent. For example, as shown in FIG. 6, the LIST_ALARMS intent has an associated entity of “RADIO_PRODUCT.” Similarly, the SOLVE_ALARM intent has associated entities of “ALARM_NAME” and “MO_TYPE,” and the INSTALL_PRODUCT intent has associated entities of “PRODUCT” and “LOCATION.”

From this information, the Question Analysis Subsystem 114 determines at step 5 that the entity “RADIO_PRODUCT” entity is missing from the input question 62.

Referring again to FIG. 4, the Question Answering Subsystem 116 will now be described.

The objective of the Question Answering Subsystem 116 is to combine the information from the Image Recognition Subsystem 112 and the Question Analysis Subsystem 114 (i.e., the text information and image information), and build a unified query for submission to the product knowledge base 160. The Question Answering Subsystem 116 then finds the most accurate answer for the composed query by submitting the unified query to the product knowledge base 160.

The Question Answering Subsystem 116 performs two main operations, illustrated in FIG. 4 as building a unified query (step 6) and retrieving the best answer from the product knowledge base (step 7).

First, the Question Answering Subsystem 116 composes a unified query by filling slots with relevant product features. For example, taking as input the analyzed question and product features extracted from the image, the missing information slots are iteratively filled to create a unified query. Since each iteration can result in a separate query, a relevance-based filtering may be used to isolate the most probable complete query. For example, if LIST_ALARMS[intent] and RADIO_PRODUCT [missing info/slot] were the output of the Question Analysis Subsystem 114, then the Question Answering Subsystem 116 matches the product features/phrases extracted from image with the RADIO_PRODUCT class and uses that to fill the missing slot. Assuming the output of the Image Recognition Subsystem 112 was RADIO_PRODUCT[“Radio”; “Ericsson”; “Radio 123” ], the Question Answering Subsystem 116 constructs a unified query of “LIST_ALARMS and RADIO_PRODUCT [Radio; Ericsson; Radio123].” The unified query may then be further expanded by replacing the identified intent (e.g., LIST_ALARMS) with a query template corresponding to the intent.

Next, the Question Answering Subsystem 116 submits the unified query to the product knowledge base 160 to retrieve the best answer for the unified query. Providing the unified query as an input, a knowledge driven question-answering (QA) system is used to find the best answers. The implementation method of the QA system is known in the art. For example, either a knowledge graph driven system or a deep neural-network language model with machine reading comprehension can be used. In the latter case, taking the unified query as input a retrieval system is first used to narrow down the relevant entries from all documents in the search space that potentially contain the answer. For the retrieval part, a sparse retriever with traditional methods, such as TF*IDF [9], BM25 [9] could be used for fast speed, or a more recent approach that is slower but more accurate dense passage retriever (DPR) [9] could be used. In the DPR setup, a bi-encoder architecture, e.g., a finetuned ELECTRA [10] model, is adopted to learn dense representations of questions and documents in order to perform semantic matching. The semantic matching for instance can be done via a FAISS [11] index. Once a short list of relevant documents is obtained, extractive question-answering may be applied via a joint reader and re-ranker model to obtain the final answer.

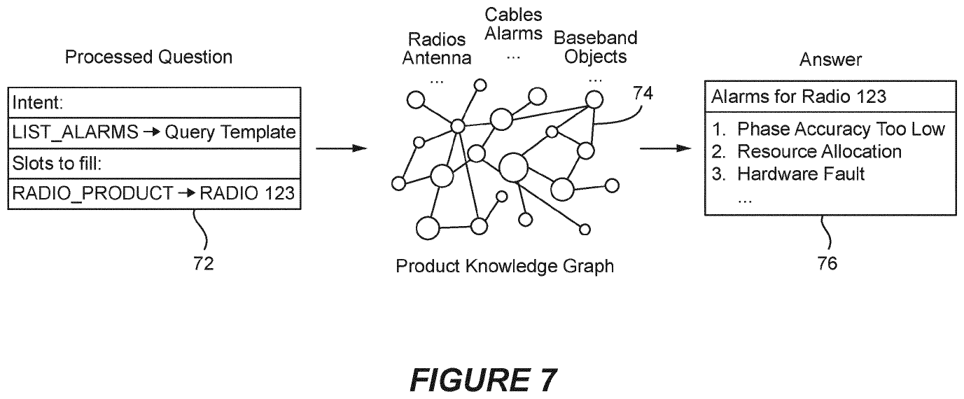

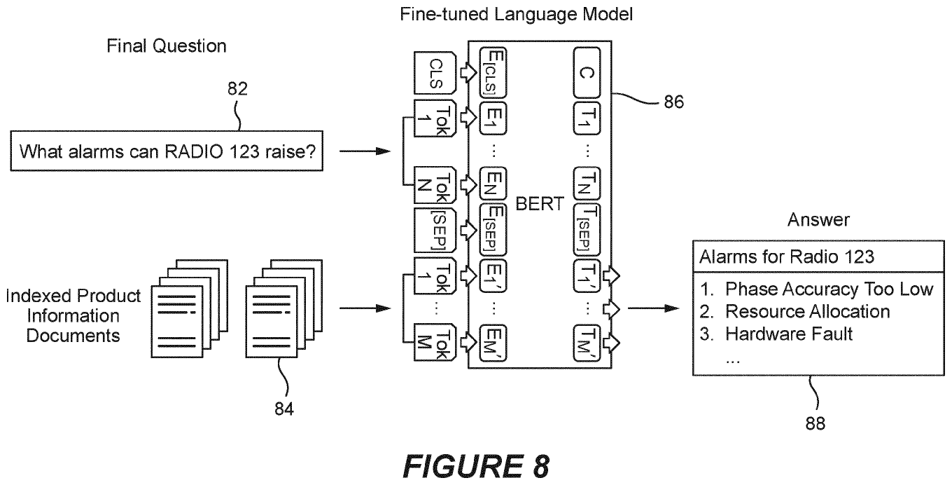

FIGS. 7 and 8 show two options of question-answering systems for response retrieval. In the example shown in FIG. 7, a unified query 72 including an intent (LIST_ALARMS) and associated entities (Radio 123) is provided to a product knowledge graph 74 that includes product information for various types of telecom products, such as radio antennas, cables, baseband objects, etc. The product knowledge graph 74 generates an answer 76 based on the query that includes alarms for Radio 123.

In the example shown in FIG. 8, a unified query 82 is generated and input to a fine-tuned language model 86 along with indexed product information documents 84. The language model 86 may, for example, include a Bidirectional Encoder Representations from Transformers (BERT) model. From the unified query 82 and the indexed product information documents 84, the language model 86 generates an answer 88 that includes alarms for Radio 123.

Referring again to FIG. 4, the Communication Interface 118 will now be described. The purpose of the Communication Interface 118 is for communicating, e.g., over a communication networks or APIs, with external systems, such as telecom site databases and/or product knowledge bases. The Communication Interface 118 may further be used to receive the natural language query from the user and to provide the obtained answer to the user.

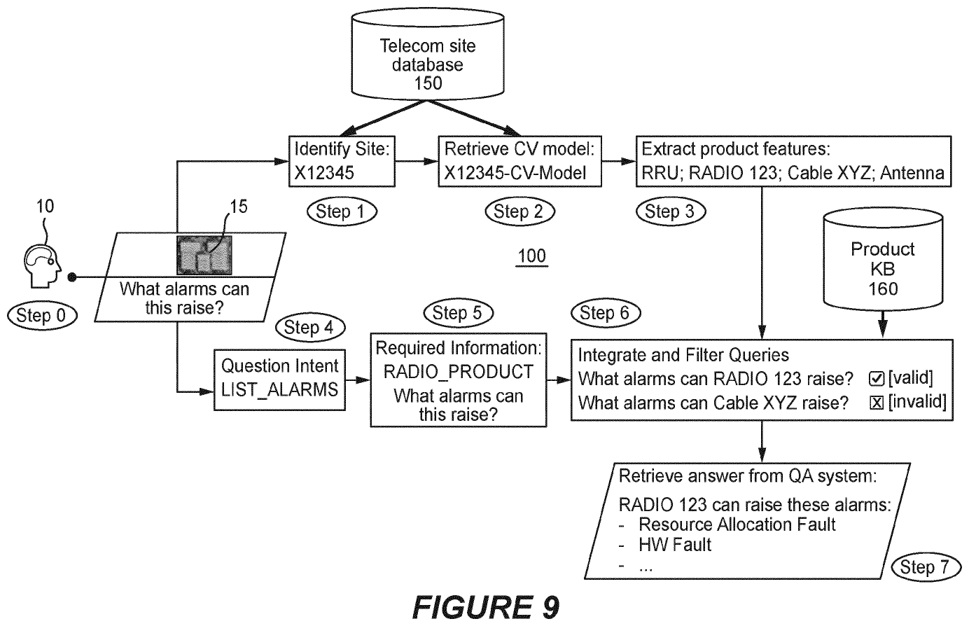

FIG. 9 illustrates an end-to-end example for asking a natural question about an item of equipment depicted in an image 15. The steps referenced in FIG. 9 correspond to the steps discussed above with reference to FIG. 4.

Referring to FIG. 9, at step 0, a user inputs an image 15 and a natural language question (“What alarms can this raise?”) to a knowledge base interface system 100. At step 1, the Image Recognition Subsystem 112 of the system 100 identifies the site associated with the image (e.g., using EXIF metadata and/or using information from the telecom site database 150) as site X12345. At step 2, the Image Recognition Subsystem 112 of the system 100 then retrieves a CV model (e.g., X12345-CV-Model) associated with the identified site. At step 3, the Image Recognition Subsystem 112 of the system 100 performs object recognition on the image and extracts product features from the image based on the retrieved CV model. For example, in this case, the system 100 extracts product features of “RRU,” “RADIO 123,” “Cable XYZ,” and “Antenna” from the image 15.

At step 4, the Question Analysis Subsystem 114 of the system 100 analyzes the natural language question to determine an intent of the question (“LIST_ALARMS”). At step 5, the Question Analysis Subsystem 114 of the system 100 identifies required information, such as required entities, that are missing from the question. For example, in this case, the system 100 determines that the entity RADIO_PRODUCT is missing from the question.

It will be appreciated that some operations of the Image Recognition Subsystem 112 and the Question Analysis Subsystem 114 of the system 100 can be performed sequentially, simultaneously or partially simultaneously. For example, steps 1, 2, and 3 may be performed by the Image Recognition Subsystem 112 before, during or after steps 4 and 5 are performed by the Question Analysis Subsystem 114.

At step 6, the Question Answering Subsystem 114 of the system 100 integrates information generated in steps 3 and 6 to form a unified query. For example, the Question Answering Subsystem 114 may fill in entity information that is missing from the natural language question using entity information extracted from the image 15. In this example, the Question Answering Subsystem 114 generates two potential queries: “What alarms can Radio 123 raise?” and “What alarms can Cable XYZ raise?” The Question Answering Subsystem 114 of the system 100 then analyzes the potential queries and determines that “What alarms can Radio 123 raise?” is a valid query because the entity “Radio 123” has associated alarms, while the query “What alarms can Cable XYZ raise?” is not a valid query because the entity “Cable XYZ” does not have any associated alarms. The Question Answering Subsystem 114 of the system 100 then submits the valid query to the product knowledge base 160 and obtains a relevant response at step 7.

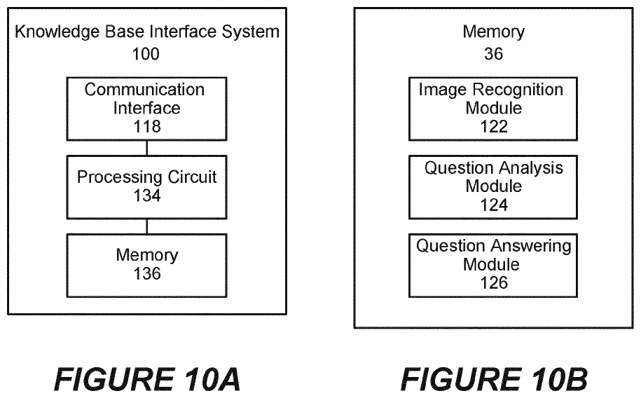

FIG. 10A is a block diagram of a knowledge base interface system 100. Various embodiments provide a knowledge base interface system 100 that includes a processor circuit 134 a communication interface 118 coupled to the processor circuit 134, and a memory 136 coupled to the processor circuit 134. The processor circuit 134 may be a single processor or may comprise a multi-processor system. In some embodiments, processing may be performed by multiple different systems that share processing power, such as in a distributed or cloud computing system. The memory 136 includes machine-readable computer program instructions that, when executed by the processor circuit, cause the processor circuit to perform some of the operations and/or implement the functions depicted described herein.

As shown, a knowledge base interface system 100 includes a communication interface 118 (also referred to as a network interface) configured to provide communications with other devices. The knowledge base interface system 100 also includes a processor circuit 134 (also referred to as a processor) and a memory circuit 136 (also referred to as memory) coupled to the processor circuit 134. According to other embodiments, processor circuit 134 may be defined to include memory so that a separate memory circuit is not required.

As discussed herein, operations of the a knowledge base interface system 100 may be performed by processing circuit 134 and/or communication interface 118. For example, the processing circuit 134 may control the communication interface 118 to transmit communications through the communication interface 118 to one or more other devices and/or to receive communications through network interface from one or more other devices. Moreover, modules may be stored in memory 136, and these modules may provide instructions so that when instructions of a module are executed by processing circuit 134, processing circuit 134 performs respective operations (e.g., operations discussed herein with respect to example embodiments.

FIG. 10B illustrates various functional modules that may be stored in the memory 136 of the knowledge base interface system 100. The modules may include an image recognition module 122 that implements the image recognition subsystem 112, a question analysis module 124 that implements the question analysis subsystem 114, and a question answering module 126 that implements the question answering subsystem 116.

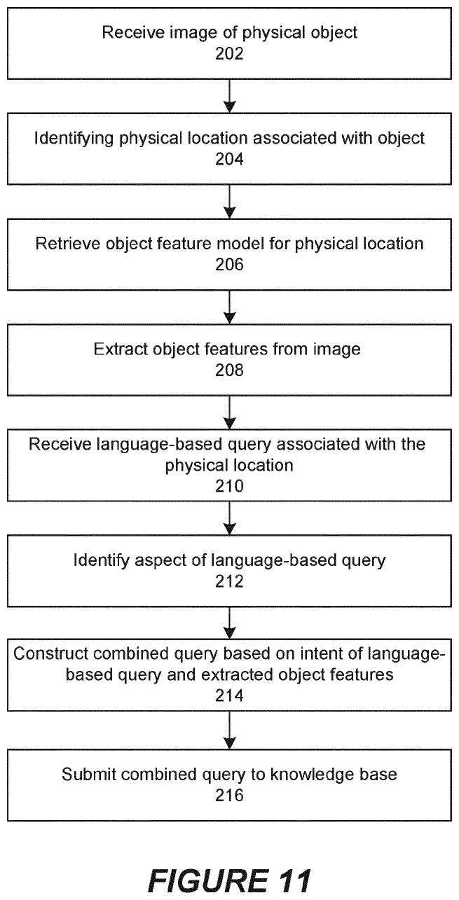

FIG. 11 is a flowchart that illustrates operations of a knowledge base interface system 100 according to some embodiments. In particular, referring to FIG. 11, a method of retrieving an answer to a query relating to a physical object from a knowledge base includes receiving (block 202) an image of the physical object, identifying (block 204) a physical location associated with the physical object, and retrieving (block 206) an object feature model associated with the physical location. The object feature model including object features associated with objects present at the physical location. The method further includes extracting (block 208) object features from the image using the object feature model. The object features include features associated with the objects present at the physical location.

The method further includes receiving (block 210) a language-based query associated with the physical object, analyzing (block 212) the language-based query to identify an aspect of the language-based query, and combining (block 214) information from the language-based query and the extracted object features based on the identified aspect of the query to form a unified query for submission to the knowledge base. The unified query is submitted (block 216) to the knowledge base to obtain an answer to the unified query.

The method may further include analyzing the image to identify the physical location.

Retrieving the object feature model is performed in response to identifying the physical location.

The method may further include analyzing the language-based query to identify missing information that is missing from the language-based query, wherein combining information from the language-based query and the extracted object features includes obtaining the missing information from the extracted object features and combining the missing information obtained from the extracted object features with the information from the language-based query.

The object feature model may include a site-specific computer vision model associated with the physical location. The object feature model may include a list of products present at the physical location.

The method may further include generating a plurality of unified queries based on information from the language-based query and the extracted object features, determining validity of the plurality of unified queries, and filtering the plurality of unified queries to eliminate invalid queries.

In some embodiments, extracting the object features may include analyzing the image with a neural network.

The aspect of the language-based query may include an intent of the language-based query, and the method includes analyzing the language-based query with a sequence classification model to determine the intent of the language-based query. The missing information may be identified based on the determined intent of the language-based query.

In some embodiments, the aspect of the language-based query may include an entity associated with the language-based query, and wherein the method includes analyzing the language-based query with a token classification model to determine the entity associated with the language-based query.

Referring to FIGS. 3 and 11, some embodiments provide a system (block 200) for retrieving an answer to a query relating to a physical object from a knowledge base. The system includes an image recognition subsystem (112) configured to receive (block 202) an image of the physical object, to identify (block 204) a physical location associated with the physical object, to retrieve (block 206) an object feature model associated with the physical location, the object feature model including object features associated with objects present at the physical location, and to extract (block 208) object features from the image using the object feature model, the object features including features associated with the objects present at the physical location. The system 100 further includes a question analysis subsystem (114) configured to receive (block 210) a language-based query associated with the physical location and to analyze (block 212) the language-based query to identify an aspect of the language-based query, and a question answering subsystem (116) configured to combine (block 214) information from the language-based query and the extracted object features to form a unified query for submission to the knowledge base and to submit (block 216) the unified query to the knowledge base to obtain an answer to the unified query.

Referring to FIGS. 10A, 10B and 11, a knowledge base interface system 100 according to some embodiments includes a processor, a communication interface coupled to the processor and configured to communicate with a knowledge base, and a memory coupled to the processor. The memory includes computer readable instructions that when executed by the processor cause the system to perform operations including receiving (block 202) an image of a physical object, identifying (block 204) a physical location associated with the physical object, retrieving (block 206) an object feature model associated with the physical location, the object feature model including object features associated with objects present at the physical location, extracting (block 208) object features from the image using the object feature model, the object features including features associated with the objects present at the physical location, receiving (block 210) a language-based query associated with the physical location, analyzing (block 212) the language-based query to identify an aspect of the language-based query, combining (block 214) information from the language-based query and the extracted object features to form a unified query for submission to the knowledge base, and submitting (block 216) the unified query to the knowledge base to obtain an answer to the unified query.

In the above-description of various embodiments of present inventive concepts, it is to be understood that the terminology used herein is for the purpose of describing particular embodiments only and is not intended to be limiting of present inventive concepts.

Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

### List of Abbreviations

| Abbreviation | Explanation |
|---|---|
| API | Application programming interface |
| BERT | Bidirectional Encoder Representations from Transformers |
| CNN | Convolutional Neural Network |
| CV | Computer vision |
| DPR | Dense Passage Retrieval |
| HW | Hardware |
| KB | Knowledge base |
| NLP | Natural Language Processing |
| NLU | Natural Language Understanding |
| NN | Neural Network |
| Q/A | Question/Answer |
| RCNN | Recurrent CNN |
| RoBERTa | Robustly Optimized BERT Pretraining Approach |
| RRU | Remote radio unit |
| TF*IDF | Term Frequency, Inverse Document Frequency |
| TMA | Tower Mounted Amplifier |
| YOLO | You Only Look Once |

### REFERENCES

[1]“unified representation,” [Online]. Available: https://worldwide.espacenet.com/patent/search/family/075759219/publication/CN112784017A?q=pn %3DCN112784017A.
[2]“FVQA,” [Online]. Available: https://arxiv.org/abs/1606.05433.
[3]“OKQ,” [Online]. Available: https://openaccess.thecvf.com/content_CVPR_2019/html/Marino_OK-VQA_A_Visual_Question_Answering_Benchmark_Requiring_External_Knowledge_CVPR_2019_paper.html.
[4]“VQA,” [Online]. Available: https://digital.library.adelaide.edu.au/dspace/bitstream/2440/127237/3/hdl_127 237.pdf.
[5]“EXIF,” [Online]. Available: http://www.cipa.jp/std/documents/e/DC-008-2012_E.pdf.
[6]“Object detection deep learning survey,” [Online]. Available: https: //arxiv.org/pdf/1907.09408.pdf.
[7]J. C. M. L. K. &. T. K. Devlin, BERT: Pre-training of Deep Bidirectional Transformers for Language Understanding, NAACL-HLT, 2019.
[8]Y. O. M. G. N. D. J. J. M. C. D. L. O. L. M. Z. L. &. S. V. Liu, RoBERTa: A Robustly Optimized BERT Pretraining Approach, ArXiv, 2019.
[9]V. O. B. M. S. L. P. W. L. E. S. C. D. &. Y. W. Karpukhin, “Dense Passage Retrieval for Open-Domain Question Answering,” in EMNLP, 2020.
[10]K. L. M. L. Q. &. M. C. Clark, “ELECTRA: Pre-training Text Encoders as Discriminators Rather Than Generators,” in ArXiv, 2020.
[11] Facebook, “FAISS: Facebook AI Similarity Search,” 2020. [Online]. Available: https://ai.facebook.com/tools/faiss/. [Accessed 14 07 2021].

1.-28. (canceled)

29. A method of obtaining an answer to a query relating to a physical object from a knowledge base, the method comprising:
obtaining an image of the physical object;
identifying a physical location associated with the physical object;
retrieving an object feature model associated with the physical location, the object feature model comprising object features associated with objects present at the physical location;
extracting object features from the image using the object feature model, the object features comprising features associated with the objects present at the physical location;
receiving a language-based query associated with the physical object;
analyzing the language-based query to identify an aspect of the language-based query;
combining information from the language-based query and the extracted object features based on the identified aspect of the query to form a unified query for submission to the knowledge base; and
submitting the unified query to the knowledge base to obtain an answer to the unified query.

30. The method of claim 29, further comprising:
analyzing the image to identify the physical location.

31. The method of claim 30, wherein retrieving the object feature model is performed in response to identifying the physical location.

32. The method of claim 29, further comprising analyzing the language-based query to identify missing information that is missing from the language-based query, wherein combining information from the language-based query and the extracted object features comprises obtaining the missing information from the extracted object features and combining the missing information obtained from the extracted object features with the information from the language-based query.

33. The method of claim 29, wherein the object feature model comprises at least one of: a site-specific computer vision model associated with the physical location and
models of objects present at the physical location.

34. The method of claim 29, further comprising:
generating a plurality of unified queries based on information from the language-based query and the extracted object features;
determining validity of the plurality of unified queries; and
filtering the plurality of unified queries to eliminate invalid queries.

35. The method of claim 29, wherein the aspect of the language-based query comprises an intent of the language-based query, and wherein the method comprises analyzing the language-based query with a sequence classification model to determine the intent of the language-based query.

36. The method of claim 35, wherein the missing information is identified based on the determined intent of the language-based query.

37. The method of claim 29, wherein the aspect of the language-based query comprises an entity associated with the language-based query, and wherein the method comprises analyzing the language-based query with a token classification model to determine the entity associated with the language-based query.

38. A system for retrieving an answer to a query relating to a physical object from a knowledge base, the system comprising:
an image recognition subsystem configured to receive an image of the physical object, to identify a physical location associated with the physical object, to retrieve an object feature model associated with the physical location, the object feature model comprising object features associated with objects present at the physical location, and to extract object features from the image using the object feature model, the object features comprising features associated with the objects present at the physical location;
a question analysis subsystem configured to receive a language-based query associated with the physical object and to analyze the language-based query to identify an aspect of the language-based query; and
a question answering subsystem configured to combine information from the language-based query and the extracted object features based on the identified aspect of the query to form a unified query for submission to the knowledge base and to submit the unified query to the knowledge base to obtain an answer to the unified query.

39. The system of claim 38 wherein the image recognition system is further configured to analyze the image of the physical location to identify the physical location.

40. The system of claim 39, wherein the image recognition system is configured to retrieve the object feature model in response to identifying the physical location.

41. The system of claim 38, wherein the question analysis system is configured to analyze the language-based query to identify missing information that is missing from the language-based query.

42. The system of claim 41, wherein the query generating system is configured to combine information from the language-based query and the extracted object features by obtaining the missing information from the extracted object features and combining the missing information obtained from the extracted object features with the information from the language-based query.

43. The system of claim 38, wherein the object feature model comprises at least one of: a site-specific computer vision model associated with the physical location and
a list of products present at the physical location.

44. The system of claim 38, wherein the query generating system is further configured to generate a plurality of unified queries based on information from the language-based query and the extracted object features, determine validity of the plurality of unified queries, and filter the plurality of unified queries to eliminate invalid queries.

45. The system of claim 38, wherein the aspect of the language-based query comprises an intent of the language-based query, and wherein the question analysis system is configured to analyze the language-based query with a sequence classification model to determine the intent of the language-based query.

46. The system of claim 45, wherein the missing information is identified in response to the determined intent of the language-based query.

47. The system of claim 38, wherein the aspect of the language-based query comprises an entity of the language-based query, and wherein the question analysis system is configured to analyze the language-based query with a token classification model to determine the entity of the language-based query.

48. A knowledge base interface system, comprising:
a processor;
a communication interface coupled to the processor and configured to communicate with a knowledge base; and
a memory coupled to the processor, wherein the memory comprises computer readable instructions that when executed by the processor cause the system to perform operations according to claim 29.
